(19) United States
(12) Patent Application Publication
(10) Pub. No.: US 2024/0243788 A1
(43) Pub. Date: Jul. 18, 2024

(54) GAIN CALIBRATION FOR MILLIMETER WAVE BEAMFORMING

(71) Applicant: QUALCOMM Incorporated, San Diego, CA (US)

(72) Inventors: Vasanthan Raghavan, West Windsor Township, NJ (US); Kobi Ravid, Closter, NJ (US); Junyi Li, Fairless Hills, PA (US)

(21) Appl. No.: 18/153,933

(22) Filed: Jan. 12, 2023

(51) Int. Cl. H04B 7/06; H04L 5/00

(52) U.S. Cl. CPC H04B 7/0617; H04L 5/0051

(57) ABSTRACT

This disclosure provides systems, methods, and devices for wireless communications that support phase and gain adjustments in beamforming for millimeter wave operation. In a first aspect, a method for wireless communications includes applying a calibration gain value to beamforming for a plurality of antennas; determining a plurality of phase calibration values corresponding to the plurality of antennas while beamforming at the calibration gain value; and determining a first plurality of gain calibration values corresponding to the plurality of antennas while beamforming using the plurality of phase calibration values. Other aspects and features are also claimed and described.

### TECHNICAL FIELD

Aspects of the present disclosure relate generally to wireless communication systems, and more particularly, to beamforming. Some features may enable and provide improved communications, including improving directionality of beams with multi-antenna arrays used at these millimeter wave and beyond carrier frequencies.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

Beamforming is one signal processing technique used in an antenna array to obtain directional signal transmission or reception. An antenna array at a mobile device may combine antenna elements in such a way that signals at particular angles experience constructive interference while others experience destructive interference. The result is that wireless signals transmitted or received at the wireless device can be directionally focused to improve reception at a particular location as compared to other locations.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Signal processing over an array of antennas during beamforming conventionally includes adjusting a phase of signals corresponding to each of the antennas in the array. Phase adjustments do not change the total power transmitted from the array, which reduces complexity of managing the array of antennas. According to aspects of this disclosure, gain adjustments/calibration may be included in the signal processing during beamforming with an array of antennas. Gain adjustments in the signal processing path change an amplitude of the signal received on or transmitted from each antenna of the array of antennas. Gain adjustments may be used for improving directionality of beams from the array of antennas, such as to control side lobes. Combining gain adjustments with phase adjustments in beamforming may be particularly advantageous in millimeter wave communications to coherently combine energy and overcome high path, propagation and blockage losses at the higher frequencies of millimeter wave communications. Upon performing gain and phase calibration for beamforming, the array of antennas can operate with more accurate gain and phase settings for a more accurate beam pattern and/or for designing a custom beam pattern.

In one aspect of the disclosure, a method for wireless communication includes applying gain values to a plurality of signals from a plurality of antennas for a beamforming operation; determining a plurality of phase calibration values corresponding to the plurality of antennas during the beamforming operation with the gain values; and determining a first plurality of gain calibration values corresponding to the plurality of antennas during the beamforming operation using the plurality of phase calibration values.

In an additional aspect of the disclosure, an apparatus includes at least one processor and a memory coupled to the at least one processor. The at least one processor is configured to perform operations including applying gain values to a plurality of signals from a plurality of antennas for a beamforming operation; determining a plurality of phase calibration values corresponding to the plurality of antennas during the beamforming operation with the gain values; and determining a first plurality of gain calibration values corresponding to the plurality of antennas during the beamforming operation using the plurality of phase calibration values.

In an additional aspect of the disclosure, an apparatus includes means for applying gain values to a plurality of signals from a plurality of antennas for a beamforming operation; means for determining a plurality of phase calibration values corresponding to the plurality of antennas during the beamforming operation with the gain values; and means for determining a first plurality of gain calibration values corresponding to the plurality of antennas during the beamforming operation using the plurality of phase calibration values.

In an additional aspect of the disclosure, a non-transitory computer-readable medium stores instructions that, when executed by a processor, cause the processor to perform operations. The operations include applying gain values to a plurality of signals from a plurality of antennas for a beamforming operation; determining a plurality of phase calibration values corresponding to the plurality of antennas during the beamforming operation with the gain values; and determining a first plurality of gain calibration values corresponding to the plurality of antennas during the beamforming operation using the plurality of phase calibration values.

In one aspect of the disclosure, a method for wireless communication includes assigning resources to a user equipment (UE) for beamforming calibration, wherein the resources comprise a first resource assignment for determining a first plurality of gain calibration values; transmitting a first signal to the UE during a first portion of the first resource assignment; receiving a second signal from the UE during a second portion of the first resource assignment; and transmitting feedback to the UE based on the second signal received during the second portion of the first resource assignment.

In an additional aspect of the disclosure, an apparatus includes at least one processor and a memory coupled to the at least one processor. The at least one processor is configured to perform operations including assigning resources to a user equipment (UE) for beamforming calibration, wherein the resources comprise a first resource assignment for determining a first plurality of gain calibration values; transmitting a first signal to the UE during a first portion of the first resource assignment; receiving a second signal from the UE during a second portion of the first resource assignment; and transmitting feedback to the UE based on the second signal received during the second portion of the first resource assignment.

In an additional aspect of the disclosure, an apparatus includes means for assigning resources to a user equipment (UE) for beamforming calibration, wherein the resources comprise a first resource assignment for determining a first plurality of gain calibration values; means for transmitting a first signal to the UE during a first portion of the first resource assignment; means for receiving a second signal from the UE during a second portion of the first resource assignment; and means for transmitting feedback to the UE based on the second signal received during the second portion of the first resource assignment.

In an additional aspect of the disclosure, a non-transitory computer-readable medium stores instructions that, when executed by a processor, cause the processor to perform operations. The operations include assigning resources to a user equipment (UE) for beamforming calibration, wherein the resources comprise a first resource assignment for determining a first plurality of gain calibration values; transmitting a first signal to the UE during a first portion of the first resource assignment; receiving a second signal from the UE during a second portion of the first resource assignment; and transmitting feedback to the UE based on the second signal received during the second portion of the first resource assignment.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3A is a block diagram illustrating an example wireless communication system that supports beamforming with phase and gain calibration according to one or more aspects.

FIG. 3B is a block diagram illustrating an example circuit configuration for a wireless communication system that supports beamforming with phase and gain calibration according to one or more aspects.

FIG. 3C is a block diagram illustrating resource assignments for phase and gain calibration according to one or more aspects.

FIG. 4 is a method for communicating on a user equipment (UE) using phase and gain calibration for beamforming according to one or more aspects.

FIG. 5 is a block diagram of an example UE that supports phase and gain calibration for beamforming according to one or more aspects.

FIG. 6 is a method for communicating on a base station (BS) using phase and gain calibration for beamforming according to one or more aspects.

FIG. 7 is a block diagram of an example base station that supports phase and gain calibration for beamforming according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support phase and gain calibration for beamforming of an array of antennas. The beamforming may be performed using resource assignments from the base station (BS) to the user equipment (UE) for the purposes of performing the phase and gain calibration and, in some aspects, the BS providing feedback to the UE as part of the calibration. In some aspects, a method for a UE and a BS to coordinate a phase and a gain/amplitude calibration for use with millimeter wave beamforming may include allocation of resources for a stage of phase calibration followed by resources for a stage of gain/amplitude calibration, in which the number of resources allocated may be based on the capability of the UE (e.g., whether the UE is capable of performing phase or signal strength measurements). In some aspects, the calibration process may be repeated for multiple operating temperatures and/or frequencies. Further, aspects of this disclosure describe a method for the BS to transmit reference signal (RS) resources while the UE is receiving, followed by the UE transmitting RS resources and the BS receiving same, followed by feedback of received signals from the BS to UE to allow estimation of calibration adjustment coefficients.

Particular implementations of the subject matter described in this disclosure may be implemented to realize one or more of the following potential advantages or benefits. In some aspects, the present disclosure provides techniques for improving the accuracy of beamforming using an array of antennas.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/see), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHZ-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHz, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHZ, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

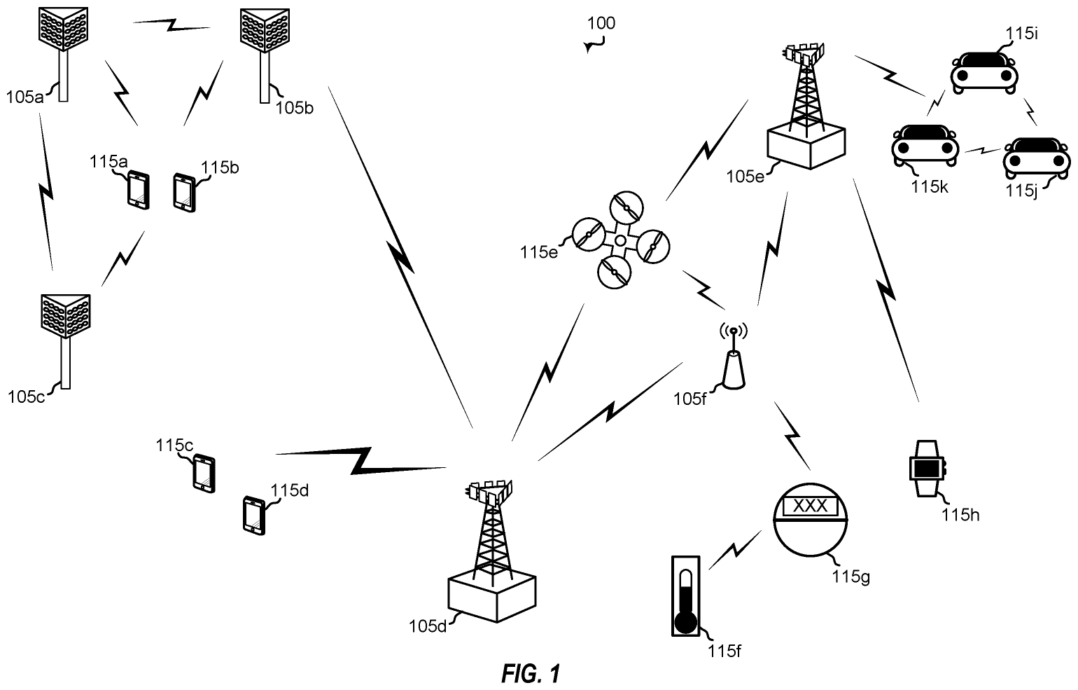

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115c-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105c.

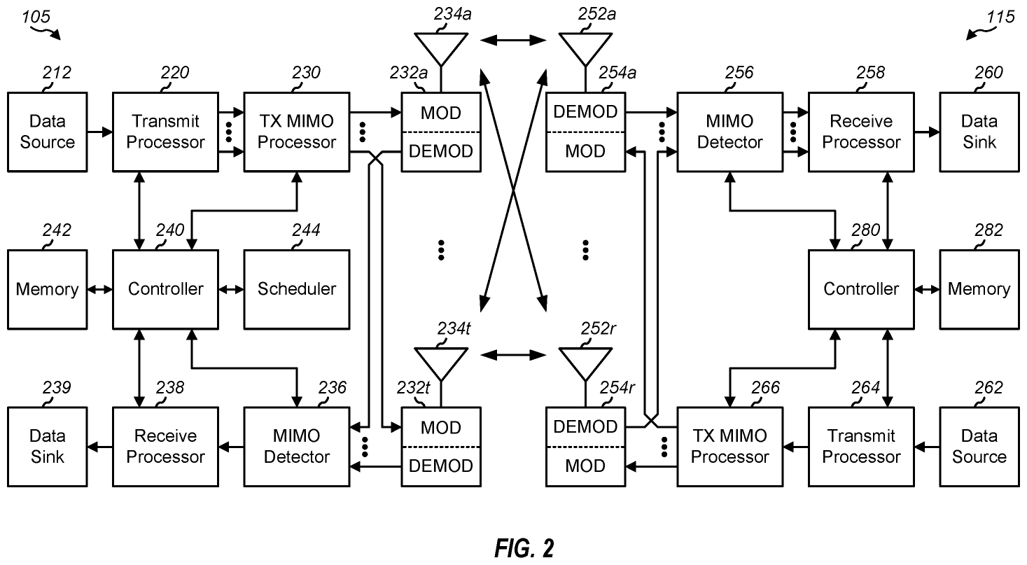

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

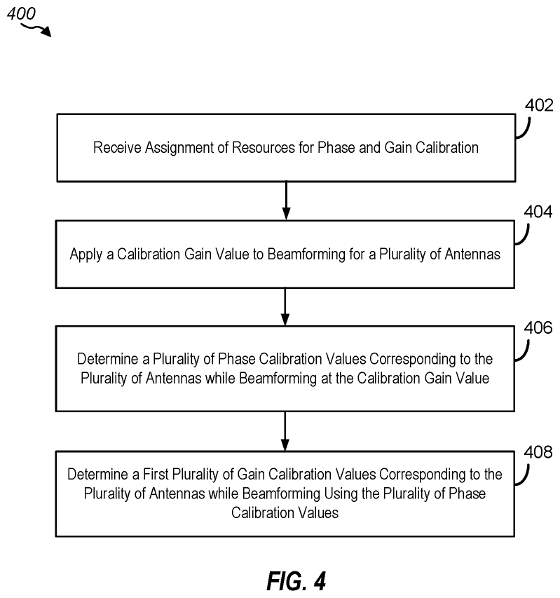

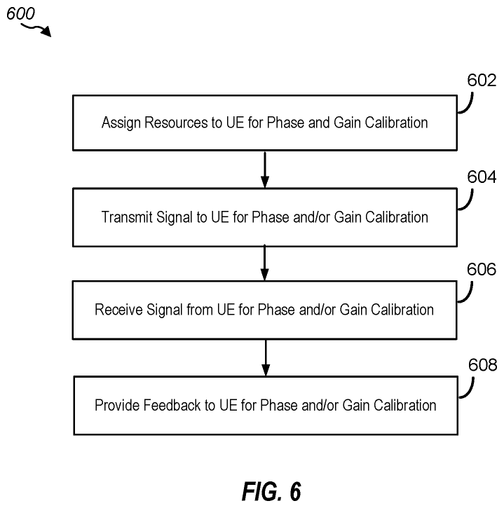

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 4 and 6, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

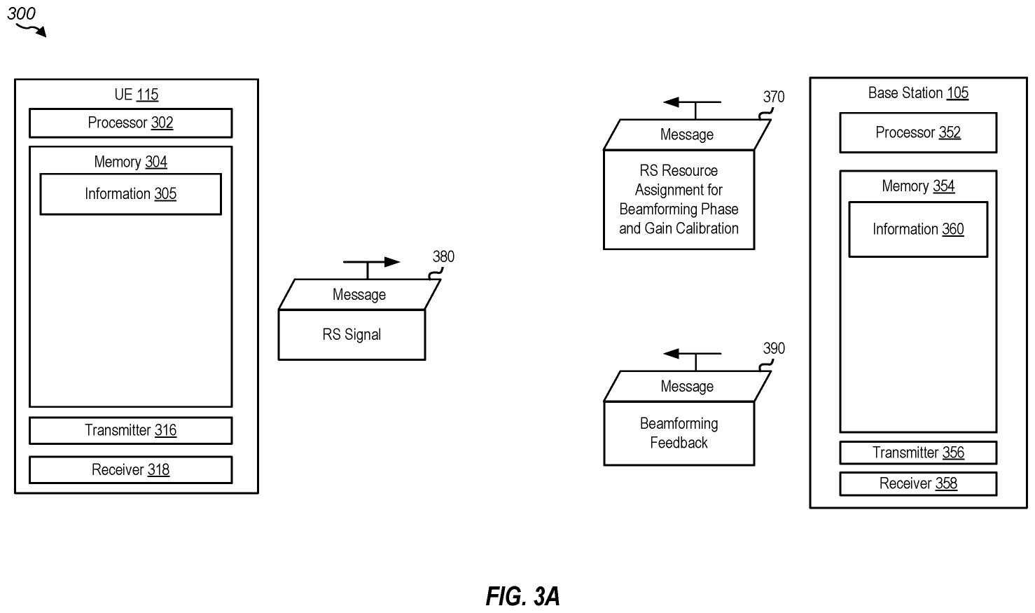

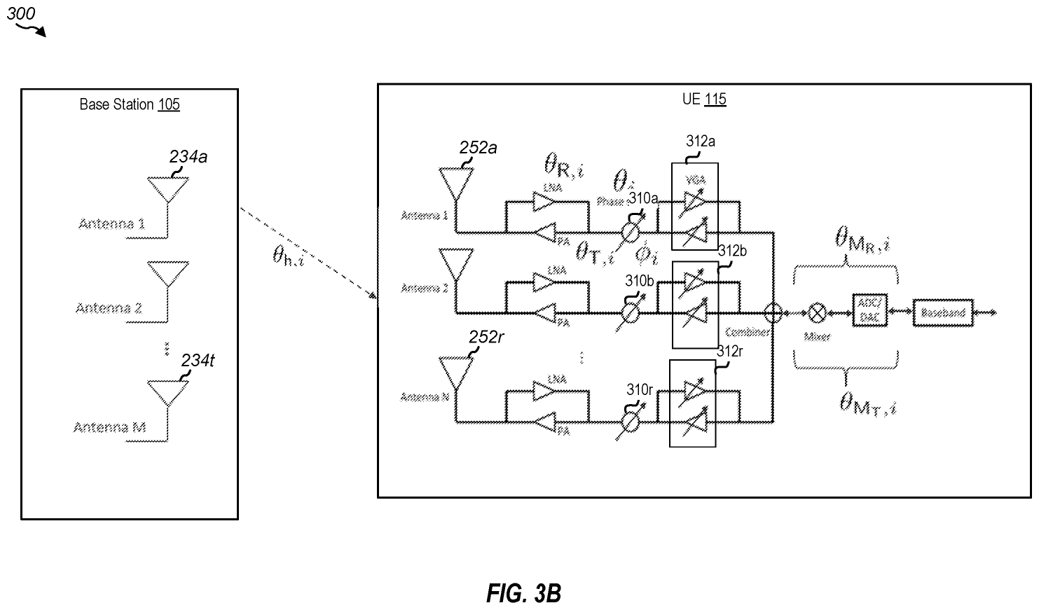

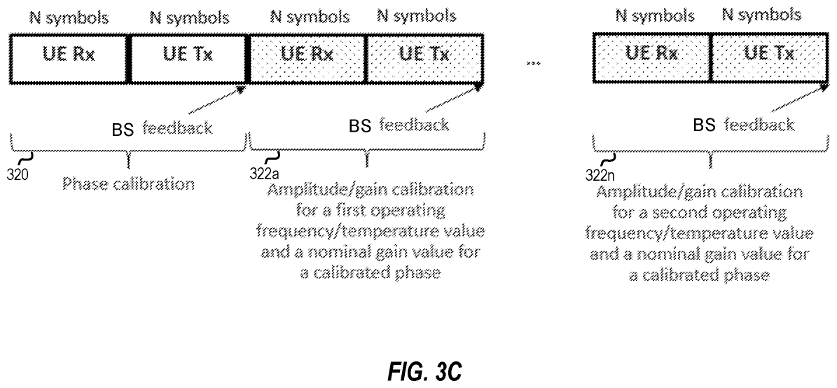

FIG. 3A is a block diagram of an example wireless communications system 300 that supports beamforming with phase and gain calibration according to one or more aspects. In some examples, wireless communications system 300 may implement aspects of wireless network 100. Wireless communications system 300 includes UE 115 and base station 105. Although one UE 115 and one base station 105 are illustrated, in some other implementations, wireless communications system 300 may generally include multiple UEs 115, and may include more than one base station 105.

UE 115 may include a variety of components (such as structural, hardware components) used for carrying out one or more functions described herein. For example, these components may include one or more processors 302 (hereinafter referred to collectively as “processor 302”), one or more memory devices 304 (hereinafter referred to collectively as “memory 304”), one or more transmitters 316 (hereinafter referred to collectively as “transmitter 316”), and one or more receivers 318 (hereinafter referred to collectively as “receiver 318”). Processor 302 may be configured to execute instructions stored in memory 304 to perform the operations described herein. In some implementations, processor 302 includes or corresponds to one or more of receive processor 258, transmit processor 264, and controller 280, and memory 304 includes or corresponds to memory 282.

Memory 304 includes or is configured to store configuration information including calibration information specifying gain and phase adjustments for each antenna in an array of antennas, with the calibration information optionally specified for specific frequencies and/or temperatures. Memory 304 may include other configuration parameters related to beamforming with an array of antennas or general network settings.

Transmitter 316 is configured to transmit reference signals, control information and data to one or more other devices, and receiver 318 is configured to receive references signals, synchronization signals, control information and data from one or more other devices. For example, transmitter 316 may transmit signaling, control information and data to, and receiver 318 may receive signaling, control information and data from, base station 105. In some implementations, transmitter 316 and receiver 318 may be integrated in one or more transceivers. Additionally or alternatively, transmitter 316 or receiver 318 may include or correspond to one or more components of UE 115 described with reference to FIG. 2.

Base station 105 may include a variety of components (such as structural, hardware components) used for carrying out one or more functions described herein. For example, these components may include one or more processors 352 (hereinafter referred to collectively as “processor 352”), one or more memory devices 354 (hereinafter referred to collectively as “memory 354”), one or more transmitters 356 (hereinafter referred to collectively as “transmitter 356”), and one or more receivers 358 (hereinafter referred to collectively as “receiver 358”). Processor 352 may be configured to execute instructions stored in memory 354 to perform the operations described herein. In some implementations, processor 352 includes or corresponds to one or more of receive processor 238, transmit processor 220, and controller 240, and memory 354 includes or corresponds to memory 242.

Memory 354 includes or is configured to store configuration information including calibration information specifying gain and phase adjustments for each antenna in an array of antennas, with the calibration information optionally specified for specific frequencies and/or temperatures. Memory 304 may include other configuration parameters related to beamforming with an array of antennas or general network settings.

Transmitter 356 is configured to transmit reference signals, synchronization signals, control information and data to one or more other devices, and receiver 358 is configured to receive reference signals, control information and data from one or more other devices. For example, transmitter 356 may transmit signaling, control information and data to, and receiver 358 may receive signaling, control information and data from, UE 115. In some implementations, transmitter 356 and receiver 358 may be integrated in one or more transceivers. Additionally or alternatively, transmitter 356 or receiver 358 may include or correspond to one or more components of base station 105 described with reference to FIG. 2.

In some implementations, wireless communications system 300 implements a 5G NR network. For example, wireless communications system 300 may include multiple 5G-capable UEs 115 and multiple 5G-capable base stations 105, such as UEs and base stations configured to operate in accordance with a 5G NR network protocol such as that defined by the 3GPP.

During operation of wireless communications system 300, the UE 115 may perform gain and/or phase calibration for beamforming. The UE 115 may request resources from the BS 105 for performing the beamforming calibration. Alternatively, the BS 105 may instruct the UE 115 to perform the beamforming calibration. The calibration process may continue with the BS 105 sending a message 370 to the UE 115 with an assignment of reference signal (RS) resources for performing phase and/or gain calibration for beamforming. The UE 115 may perform one or more measurements, such as phase measurements of the channel impulse response (CIR) over the reference signals and/or reference signal received power (RSRP) measurements. The UE 115 may transmit a reference signal in message 380 to the BS 105. The BS 105 may provide feedback, in message 390, to the UE 115 regarding the UE 115's beamforming configuration and/or the measurement values.

One example circuit for performing beamforming using phase and gain calibration is shown in FIG. 3B. FIG. 3B is a block diagram illustrating an example circuit configuration for a wireless communication system that supports beamforming with phase and gain calibration according to one or more aspects. The BS 105 may include antennas 234a-234t. The UE 115 may include antennas 252a-252r. The UE 115 may include additional circuitry for processing signals received on antennas 252a-252r. For example, the UE 115 may include phase shifters 310a-310r corresponding to antennas 252a-252r. As another example, the UE 115 may include variable gain adjustments (VGAs) 312a-312r corresponding to antennas 252a-252r. The UE 115 may determine values for the phase shifters 310a-310r and VGAs 312a-312r to provide a specific beam direction, such as to use the array of antennas 252a-252r for directional communication to the BS 105.

Adjustments for beamforming in the system 300 to obtain a specific beamformed channel using gain and phase values can be described in terms of h=Hf, in which h is the BS-beamformed channel between the UE 115 and the BS 105. Assuming noise-free reception at the i-th antenna of the UE 115, the following equations describe the receive channel at the i-th antenna:

$${y}_{R , i} = {α}_{i} \cdot {A}_{i} \cdot {e}^{j ( {θ}_{i} + {θ}_{h , i} + {θ}_{{M}_{R} , i} + {θ}_{R , i} )} ,$$

in which:
θ_{h,i}=phase of channel impulse response at i-th antenna in receive mode,
θM_{R,i}=phase of mixer and ADC in the i-th receive path,
θ_{R,i}=phase of all other RF components in the i-th path (e.g., LNA, couplers, filters, VGAs, etc.),
θᵢ=phase to which phase shifter at i-th antenna in receive mode is set,
αᵢ=gain of all RF components (incl. mixer), channel and phase shifter in the i-th receive path, and
Aᵢ=gain of VGA in Rx mode.

Likewise, assuming transmission from the i-th antenna at the UE 115, the following equations describe the received signal at the BS 105:

$${y}_{T , i} = {β}_{i} \cdot {B}_{i} \cdot {e}^{j ( {ϕ}_{i} + {θ}_{h , i} + {θ}_{{M}_{T} , i} + {θ}_{T , i} )} ,$$

in which:
θ_{h,i}=phase of channel impulse response at i-th antenna in transmit mode,
θM_{T,i}=phase of mixer and DAC in the i-th transmit path,
θ_{T,i}=phase of all other RF components in the i-th path (PA, couplers, filters, VGAs, etc.),
ϕᵢ=phase to which phase shifter at i-th antenna in receive mode is set,
βᵢ=gain of all RF components (incl. mixer), channel and phase shifter in the i-th transmit path, and
Bᵢ=gain of VGA in Tx mode.

An example assignment of resources for phase and gain calibration is shown in FIG. 3C. FIG. 3C is a block diagram illustrating resource assignments for phase and gain calibration according to one or more aspects. The resource assignments may be made in pairs, in which a first set of resources is used for UE reception and the second set of resources is used for UE transmission. Each of the resources may include N symbols, although the assignments for transmission and reception need not be symmetrical. That is, there may be N₁ symbols assigned for UE reception and N₂ symbols assigned for UE transmission, in which N₁ is not equal to N₂.

The calibration process may proceed through several steps including a phase calibration 320, a first gain calibration 322a, and subsequent gain calibrations 322b-n. Each of the steps 320 and 322a-n may include a first set of N₁ symbols for UE reception and N₂ symbols for UE transmission, followed by BS feedback to the UE. In some aspects, multiple gain calibrations 322a-n may be performed for different operating points, each operating point having a frequency and a temperature.

As described with reference to FIGS. 3A-C, the present disclosure provides techniques for providing gain adjustment calibrations for beamforming to improve the directional control of the beam to improve the communications channel between the UE 115 and the BS 105.

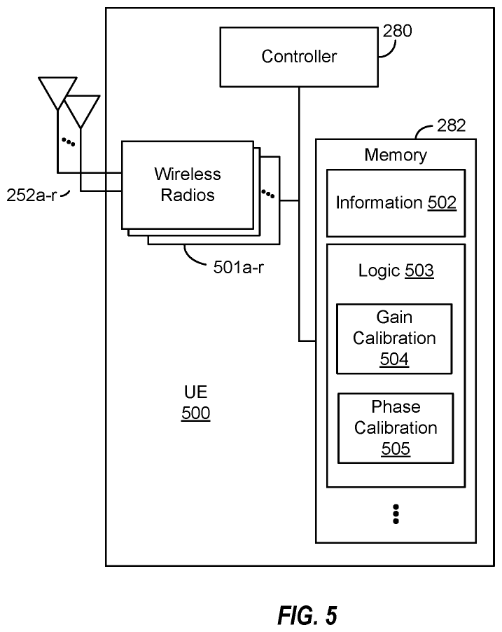

FIG. 4 is a flow diagram illustrating an example process 400 that supports phase and gain calibration for beamforming according to one or more aspects. Operations of process 400 may be performed by a UE, such as UE 115 described above with reference to FIGS. 1, 2, 3A-C, or a UE described with reference to FIG. 5. For example, example operations (also referred to as “blocks”) of process 400 may enable UE 115 to support beamforming with gain and phase calibrations.

In block 402, the UE may receive an assignment of resources for performing phase and/or gain calibration for beamforming with an array of antennas at the UE. The assignment may include reference signal (RS) resources. The assignment may include a first portion for receiving a set of RS resources and a second portion for transmitting a set of RS resources.

In block 404, the UE may apply calibrated gain values to a plurality of signals for a beamforming operation with the array of antennas at the UE. The beamforming operation may be a beamforming calibration process as described in embodiments of this application. This may be a predetermined value that is applied to all antennas in the array for the purposes of calibrating phase adjustments of the antennas. The predetermined value may be configured by the BS, configured in a firmware of the UE, or determined based on network conditions prior to performing the calibration of blocks 406 and 408. In some embodiments, the calibrated gain values may be equal gains for all of the plurality of signals.

In block 406, the UE 115 may determine a plurality of phase calibration values corresponding to the plurality of antennas with the array of antennas during the beamforming operation with the calibrated gain values of block 404. The phase calibration may be performed to establish the phase adjustment for each of the beams corresponding to the plurality of antennas. After phase calibration of block 404 is completed, the UE 115 may continue to gain adjustment calibration. In some aspects, the UE 115 may perform the phase calibration without a subsequent gain calibration. In some aspects, the UE 115 may perform the gain calibration without the phase calibration. In some aspects, the UE 115 may perform the gain calibration before the phase calibration, in which the gain calibration values may be used for the phase calibration or the predetermined calibration gain value may be used for the phase calibration.

The calibration at block 406 may include the UE being configured with equal gain amplitudes Aᵢ=A and Bᵢ=B for all antennas i=1, . . . , N. For N antennas at the UE 115, 2N symbols may be assigned for two-way communications between the BS 105 and the UE 115 (N symbols for UE to receive and N symbols for UE to transmit). If the UE is only capable of performing RSRP measurements, instead of phase measurements, for received signals then the UE 115 may be assigned additional symbols for performing phase calibration. The UE may set up receive phases {θᵢ*} optimally and Tx phases {ϕᵢ*} to match for transmit-receive circuit level mismatches.

The phase calibration of block 406 may be performed during a first resource assignment, and may include a first N₁ number of symbols to enable UE reception for phase calibration and may include a second N₂ number of symbols to enable UE transmission for phase calibration. The determination of phase calibration values may be performed based on aspects of the received signals during the first N₁ number of symbols and feedback received from the BS 105 based on transmitted signals during the second N₂ number of symbols.

In block 408, the UE may determine a first plurality of gain calibration values corresponding to the plurality of antennas during the beamforming operation using the plurality of phase calibration values determined at block 406. The calibration of blocks 406 and 408 may be repeated periodically due to temperature variations at the UE 115 and/or change in frequency of operation for communications between the UE 115 and the BS 105.

The calibration at block 408 may assume that the UE 115 can make phase measurements or RSRP-only measurements. If phase measurements can be performed by UE 115, with receive phases {θᵢ^{k}} and transmit phases {ϕᵢ^{k}} appropriately chosen over k=1, . . . , N symbols, the received signals at the UE 115 and the BS 105 corresponding to use of a single antenna at the UE 115 may be determined as:

$${y}_{R}^{k} = {\sum }_{i = 1}^{N} {α}_{i} \cdot {A}_{i} \cdot {e}^{j ( {θ}_{i}^{k} + {θ}_{h , i} + {θ}_{{M}_{R} , i} + {θ}_{R , i} )} , and$$

$${y}_{T}^{k} = {\sum }_{i = 1}^{N} {β}_{i} \cdot {B}_{i} \cdot {e}^{j ( {ϕ}_{i}^{k} + {θ}_{h , i} + {θ}_{{M}_{T} , i} + {θ}_{T , i} )} .$$

Accumulated over N symbols, these signals can be represented in matrix form as given below:

$$[ \begin{matrix}{y}_{R}^{1} & … & {y}_{R}^{N}\end{matrix} ] = [ \begin{matrix}{α}_{1} \cdot {A}_{1} & … & {α}_{N} \cdot {A}_{N}\end{matrix} ] \cdot [ \begin{matrix}{e}^{j ( θ \text{?} + θ \text{?} + {θ}_{{M}_{R} , i} + {θ}_{R , i} )} & … & {e}^{j ( θ \text{?} + θ \text{?} + {θ}_{{M}_{R} , i} + {θ}_{R , i} )} \\ ⋮ & ⋱ & ⋮ \\ {e}^{j ( θ \text{?} + θ \text{?} + {θ}_{{M}_{R}} \text{?} + {θ}_{R , N} )} & … & {e}^{j ( θ \text{?} + θ \text{?} + θ \text{?} + {θ}_{R , N} )}\end{matrix} ] , and$$

$$[ \begin{matrix}{y}_{T}^{1} & … & {y}_{T}^{N}\end{matrix} ] = [ \begin{matrix}{β}_{1} \cdot {B}_{1} & … & {β}_{N} \cdot {B}_{N}\end{matrix} ] \cdot [ \begin{matrix}{e}^{j ( ϕ \text{?} + θ \text{?} + {θ}_{{M}_{T} , 1} + {θ}_{T , 1} )} & … & {e}^{j ( ϕ \text{?} + θ \text{?} + {θ}_{{M}_{T} , 1} + {θ}_{T , 1} )} \\ ⋮ & ⋱ & ⋮ \\ {e}^{j ( ϕ \text{?} + θ \text{?} + {θ}_{{M}_{T}} \text{?} + {θ}_{T , N} )} & … & {e}^{j ( ϕ \text{?} + θ \text{?} + θ \text{?} + {θ}_{T , N} )}\end{matrix} ] .$$

$$\text{?} \text{indicates text missing or illegible when filed}$$

Within these formulae, the optimal receive and transmit phases {θᵢ*} and {ϕᵢ*} are known from the phase calibration at block 404, and {θ_{h,i}+θM_{R,i}+θ_{R,i}} and {θ_{h,i}+θM_{T,i}+θ_{T,i}} are known because receive/transmit phases {θᵢ^{k}} and {ϕᵢ^{k}}, and receive/transmit amplitudes {Aᵢ} and {Bᵢ} are chosen by the UE over the N symbols, resulting in the matrices on the right-hand side being known. The BS 105 provides feedback of {y_{Tk}} to UE 115 obtained over the N symbols. The UE 115 determines {αᵢ} and {βᵢ} from this information, and the UE 115 determines how to adjust {Bᵢ} in response to receive/transmit circuitry mismatches and match {Bᵢ} to {Aᵢ}.

If RSRP-only measurements are available at the UE 115, with receive phases {θᵢ^{k}} and transmit phases {ϕᵢ^{k}} appropriately chosen over k=1, . . . , N symbols, equations may be defined as given below:

$${RSRP}_{R}^{k} = {\vert {\sum }_{i = 1}^{N} {α}_{i} \cdot {A}_{i} \cdot {e}^{j ( {θ}_{i}^{k} + {θ}_{h , i} + {θ}_{{M}_{R} , i} + {θ}_{R , i} )} \vert}^{2} , and$$

$${RSRP}_{T}^{k} = {\vert {\sum }_{i = 1}^{N} {β}_{i} \cdot {B}_{i} \cdot {e}^{j ( {ϕ}_{i}^{k} + {θ}_{h , i} + {θ}_{{M}_{T} , i} + {θ}_{T , i} )} \vert}^{2} .$$

By setting Aₖ=1 for the k-th symbol with Aᵢ=0 (where i≠k), the UE 115 can determine {αᵢ}. Similarly, by setting Bₖ=1 for the k-th symbol with Bᵢ=0 (where i≠k), the UE 115 can determine {βᵢ}. This constructive procedure may use 2N symbols, even though there is no beamforming gain in any of these 2N symbols. Other constructive procedures can be performed (over 2N symbols), in which beamforming gain can be realized in estimating {αᵢ} and {βᵢ}. For each phase value (after phase calibration of block 404), there may be multiple relevant gain/amplitude settings. Aᵢ may be generalized to A_{i,j} for different j (index values on relevant amplitudes) for each i (index for phase value). In some aspects, amplitude/gain contributions may be coupled with phase contributions (such that they are not independent). In these aspects, there may be a look-up table associated with amplitude/gain values and phase values, and based on measurements and the look-up table, the UE 115 may determine phase and gain adjustment values during calibration of blocks 406 and 408.

FIG. 5 is a block diagram of an example UE 500 that supports phase and gain calibration for beamforming according to one or more aspects. UE 500 may be configured to perform operations, including the blocks of a process described with reference to FIG. 4. In some implementations, UE 500 includes the structure, hardware, and components shown and described with reference to UE 115 of FIGS. 1-3. For example, UE 500 includes controller 280, which operates to execute logic or computer instructions stored in memory 282, as well as controlling the components of UE 500 that provide the features and functionality of UE 500. UE 500, under control of controller 280, transmits and receives signals via wireless radios 501a-r and antennas 252a-r. Wireless radios 501a-r include various components and hardware, as illustrated in FIG. 2 for UE 115 and/or in FIG. 3B for UE 115, including modulator and demodulators 254a-r. MIMO detector 256, receive processor 258, transmit processor 264, TX MIMO processor 266, phase offset injectors, and/or variable gain adjusts (VGAs).

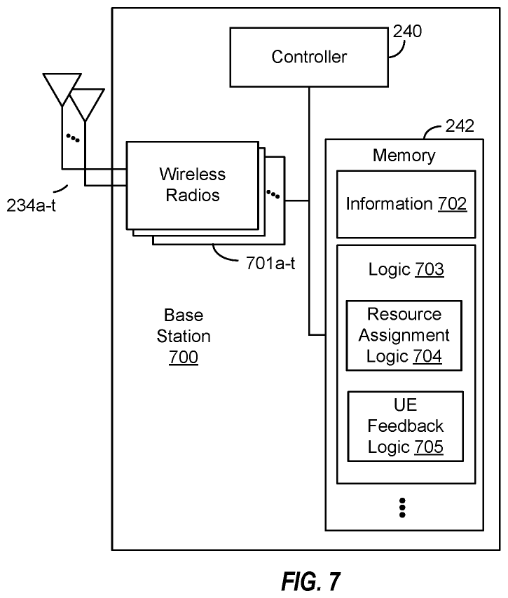

As shown, memory 282 may include information 502, such as gain and phase calibration adjustment values, logic 503 (including gain calibration logic 504, and phase calibration logic 505). Logic 503 may be configured to perform steps for calibration as described herein, such as with respect to block 406 and 408 of FIG. 4. UE 500 may receive signals from or transmit signals to one or more network entities, such as base station 105 of FIGS. 1-3 or a base station as illustrated in FIG. 7.

FIG. 6 is a flow diagram illustrating an example process 600 that supports using phase and gain calibration for beamforming according to one or more aspects. Operations of process 600 may be performed by a base station, such as base station 105 described above with reference to FIGS. 1-3 or a base station as described above with reference to FIG. 7. For example, example operations of process 600 may enable base station 105 to support phase and gain calibration for beamforming at UE 115.

At block 602, the base station assigns resources to the UE 115 for phase and gain calibration. The BS 105 may determine that beamforming adjustments should be performed at the UE 115 based on measurements made by the BS 105 and/or reports received from the UE 115, or based on other criteria such as time intervals. The resource assignment may include one or more of the example resources described herein, such as the assignments shown in FIG. 3C.

At block 604, the base station transmits a signal, such as a reference signal (RS), to the UE 115 for phase and/or gain calibration for beamforming. The transmission at block 604 may correspond to a UE receive period, such as in the first portion of the phase calibration 320.

At block 606, the base station receives a signal from the UE, such as a reference signal (RS), for phase calibration for beamforming. The reception at block 606 may correspond to a UE transmit period, such as in the second portion of the phase calibration 320.

Blocks 604 and 606 may be repeated for additional calibrations, such as first and second portions of the phase calibration 322a, and additional phase or gain calibrations 322b-n.

At block 608, feedback is provided by the BS to the UE to improve phase or gain calibration. In particular, the BS 105 may feedback the yr values to the UE 115 either in the form of phases of the channel impulse response or the RSRP associated with these transmissions. This feedback can be over a control channel such as the physical uplink control channel (PUCCH) or uplink control information (UCI) or multiple access control-control element (MAC-CE) or radio resource control (RRC) message.

In some implementations, in which a phase and gain calibration is performed by the UE, the BS may begin a phase calibration cycle by assigning resources at block 602, and enter into the phase calibration by transmitting a RS signal at block 604, receiving a RS signal at block 606, and providing feedback at block 608. In some aspects, no feedback is provided during the phase calibration. The process 600 may be repeated for gain calibration, including assigning new resources at block 602, transmitting signals to the UE at block 604, receiving signals from the UE at block 606, and providing feedback to the UE at block 608. In some aspects, a single resource assignment operation is made at block 602, and multiple calibrations, including calibrations 320 and 322a-n of FIG. 3C, are performed based on a single resource assignment. In such aspects, a method may include performing the step of block 602, followed by blocks 604 and 606 for phase calibration 320, followed by blocks 604, 606, and 608 for gain calibration 322a.

FIG. 7 is a block diagram of an example base station 700 that supports phase and gain calibration for beamforming according to one or more aspects. Base station 700 may be configured to perform operations, including the blocks of process 600 described with reference to FIG. 6. In some implementations, base station 700 includes the structure, hardware, and components shown and described with reference to base station 105 of FIGS. 1-3. For example, base station 700 may include controller 240, which operates to execute logic or computer instructions stored in memory 242, as well as controlling the components of base station 700 that provide the features and functionality of base station 700. Base station 700, under control of controller 240, transmits and receives signals via wireless radios 701a-t and antennas 734a-t. Wireless radios 701a-t include various components and hardware, as illustrated in FIG. 2 for base station 105, including modulator and demodulators 232a-t, transmit processor 220, TX MIMO processor 230, MIMO detector 236, and receive processor 238.

As shown, the memory 242 may include information 702, logic 703, resource assignment logic 704, and UE feedback logic 705. Information 702 may be configured to include configuration information including calibration information specifying gain and phase adjustments for each antenna in an array of antennas, with the calibration information optionally specified for specific frequencies and/or temperatures. Memory 304 may include other configuration parameters related to beamforming with an array of antennas or general network settings. Resource assignment logic 704 may be configured to determine resource assignments, such as allocation of channels and resources for UEs within the cell corresponding to the base station 700, including scheduling of reference signal (RS) resources to accommodate phase and/or gain calibration of beamforming at UEs. UE feedback logic 705 may be configured to determine feedback to provide to the UE based on reception of the RS transmitted by the UE for beamforming calibration. Base station 700 may receive signals from or transmit signals to one or more UEs, such as UE 115 of FIGS. 1-3 or UE 500 of FIG. 5.

It is noted that one or more blocks (or operations) described with reference to FIGS. 4 and 6 may be combined with one or more blocks (or operations) described with reference to another of the figures. For example, one or more blocks (or operations) of FIG. 4 may be combined with one or more blocks (or operations) of FIG. 3C. As another example, one or more blocks associated with FIG. 4 may be combined with one or more blocks associated with FIG. 3B. As another example, one or more blocks associated with FIG. 6-7 may be combined with one or more blocks (or operations) associated with FIGS. 1-3. Additionally, or alternatively, one or more operations described above with reference to FIGS. 1-3 may be combined with one or more operations described with reference to FIG. 5 or 7.

In one or more aspects, techniques for supporting beamforming during wireless communications may include additional aspects, such as any single aspect or any combination of aspects described below or in connection with one or more other processes or devices described elsewhere herein. In a first aspect, supporting beamforming may include an apparatus configured to calibrate gain values before phase calibration values as part of a beamforming calibration process. Further, the apparatus may be configured for applying gain values to a plurality of signals from a plurality of antennas for a beamforming operation; determining a plurality of phase calibration values corresponding to the plurality of antennas during the beamforming operation with the gain values; and determining a first plurality of gain calibration values corresponding to the plurality of antennas during the beamforming operation using the plurality of phase calibration values. Additionally, the apparatus may perform or operate according to one or more aspects as described below. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the apparatus is further configured to perform operations including receiving, by the user equipment, a first resource assignment for determining the plurality of phase calibration values, wherein the determining the plurality of phase calibration values is performed using the first resource assignment; and receiving, by the user equipment, a second resource assignment for determining the first plurality of gain calibration values, wherein the determining the first plurality of gain calibration values is performed using the second resource assignment.

In a third aspect, in combination with one or more of the first aspect or the second aspect, the apparatus is further configured to perform operations including receiving, by the user equipment, a third resource assignment for determining a second plurality of gain calibration values; and determining a second plurality of gain calibration values corresponding to the plurality of antennas during the beamforming operation using the plurality of phase calibration values using the third resource assignment.

In a fourth aspect, in combination with one or more of the first aspect through the third aspect.

In a fifth aspect, in combination with one or more of the first aspect through the fourth aspect, the first plurality of gain calibration values correspond to a first operating point comprising a first frequency and a first temperature value, the second plurality of gain calibration values correspond to a second operating point comprising a second frequency and a second temperature value, and at least one of: the second frequency is different from the first frequency or the second temperature value is different from the first temperature value.

In a sixth aspect, in combination with one or more of the first aspect through the fifth aspect, determining the plurality of phase calibration values comprises receiving, by the user equipment, first feedback from a base station, wherein the plurality of phase calibration values is based on the first feedback, and determining the first plurality of gain calibration values comprises receiving, by the user equipment, second feedback from the base station, wherein the first plurality of gain calibration values is based on the second feedback.

In a seventh aspect, in combination with one or more of the first aspect through the sixth aspect, the first resource assignment comprises a first number of symbols for which the user equipment is configured for determining the plurality of phase calibration values based on phase measurements, and the first resource assignment comprises a second number of symbols greater than the first number of symbols for which the user equipment is configured for determining the plurality of phase calibrations values based on signal strength measurements.

In an eighth aspect, in combination with one or more of the first aspect through the seventh aspect, first resource assignment comprises a first reference signal (RS) resource assignment, and the second resource assignment comprises a second reference signal (RS) resource assignment.

In a ninth aspect, in combination with one or more of the first aspect through the eighth aspect, determining the plurality of phase calibration values comprises transmitting a first reference signal (RS) in a millimeter wave band, and determining the first plurality of gain calibration values comprises transmitting a first reference signal (RS) in the millimeter wave band.

In one or more aspects, techniques for supporting beamforming may include additional aspects, such as any single aspect or any combination of aspects described below or in connection with one or more other processes or devices described elsewhere herein. In a tenth aspect, supporting beamforming may include an apparatus configured to provide resource assignments for and feedback to a user equipment for use in a beamforming calibration process. The apparatus is further configured to perform operations including assigning resources to a user equipment (UE) for beamforming calibration, wherein the resources comprise a first resource assignment for determining a first plurality of gain calibration values; transmitting a first signal to the UE during a first portion of the first resource assignment; receiving a second signal from the UE during a second portion of the first resource assignment; and transmitting feedback to the UE based on the second signal received during the second portion of the first resource assignment. Additionally, the apparatus may perform or operate according to one or more aspects as described below. In some implementations, the apparatus includes a wireless device, such as a base station. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In an eleventh aspect, in combination with the tenth aspect, assigning the resources to the UE comprises assigning a second resource assignment for determining a plurality of phase calibration values.

In a twelfth aspect, in combination with any one of the tenth through eleventh aspects, assigning the resources to the UE comprises assigning a third resource assignment to the UE for determining a second plurality of gain calibration values.

In a thirteenth aspect, in combination with any one of the tenth through twelfth aspects, the first plurality of gain calibration values correspond to a first operating point comprising a first frequency and a first temperature value, the second plurality of gain calibration values correspond to a second operating point comprising a second frequency and a second temperature value, and at least one of the second frequency is different from the first frequency or the second temperature value is different from the first temperature value.

In a fourteenth aspect, in combination with any one of the tenth through thirteenth aspects, the second resource assignment comprises a first number of symbols during which the user equipment is configured for determining the plurality of phase calibration values based on phase measurements, and the second resource assignment comprises a second number of symbols greater than the first number of symbols during which the user equipment is configured for determining the plurality of phase calibrations values based on RSRP measurements.

In a fifteenth aspect, in combination with any one of the tenth through fourteenth aspects, the first resource assignment comprises a first reference signal (RS) resource assignment, and the second resource assignment comprises a second reference signal (RS) resource assignment.

In a sixteenth aspect, in combination with any one of the tenth through fifteenth aspects, transmitting the first signal to the UE during the first portion of the first resource assignment comprise transmitting a first reference signal (RS) in a millimeter wave band.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-7 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for case of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A user equipment (UE) comprising:
a memory storing processor-readable code; and
at least one processor coupled to the memory, the at least one processor configured to execute the processor-readable code to cause the at least one processor to perform operations including:
applying gain values to a plurality of signals from a plurality of antennas for a beamforming operation;
determining a plurality of phase calibration values corresponding to the plurality of antennas during the beamforming operation with the gain values; and
determining a first plurality of gain calibration values corresponding to the plurality of antennas during the beamforming operation using the plurality of phase calibration values.

2. The user equipment of claim 1, wherein the at least one processor is further configured to perform operations including:
receiving, by the user equipment, a first resource assignment for determining the plurality of phase calibration values, wherein the determining the plurality of phase calibration values is performed using the first resource assignment; and
receiving, by the user equipment, a second resource assignment for determining the first plurality of gain calibration values, wherein the determining the first plurality of gain calibration values is performed using the second resource assignment.

3. The user equipment of claim 2, wherein the at least one processor is further configured to perform operations including:
receiving, by the user equipment, a third resource assignment for determining a second plurality of gain calibration values; and
determining a second plurality of gain calibration values corresponding to the plurality of antennas during the beamforming operation using the plurality of phase calibration values using the third resource assignment.

4. The user equipment of claim 3, wherein:
the first plurality of gain calibration values correspond to a first operating point comprising a first frequency and a first temperature value,
the second plurality of gain calibration values correspond to a second operating point comprising a second frequency and a second temperature value, and
at least one of: the second frequency is different from the first frequency or the second temperature value is different from the first temperature value.

5. The user equipment of claim 2, wherein:
determining the plurality of phase calibration values comprises receiving, by the user equipment, first feedback from a base station, wherein the plurality of phase calibration values is based on the first feedback; and
determining the first plurality of gain calibration values comprises receiving, by the user equipment, second feedback from the base station, wherein the first plurality of gain calibration values is based on the second feedback.

6. The user equipment of claim 2, wherein:
the first resource assignment comprises a first number of symbols for which the user equipment is configured for determining the plurality of phase calibration values based on phase measurements, and
the first resource assignment comprises a second number of symbols greater than the first number of symbols for which the user equipment is configured for determining the plurality of phase calibrations values based on signal strength measurements.

7. The user equipment of claim 2, wherein the first resource assignment comprises a first reference signal (RS) resource assignment, and the second resource assignment comprises a second reference signal (RS) resource assignment.

8. The user equipment of claim 1, wherein:
determining the plurality of phase calibration values comprises transmitting a first reference signal (RS) in a millimeter wave band, and
determining the first plurality of gain calibration values comprises transmitting a first reference signal (RS) in the millimeter wave band.

9. A method of wireless communication performed by a user equipment (UE), the method comprising:
applying gain values to a plurality of signals from a plurality of antennas for a beamforming operation;
determining a plurality of phase calibration values corresponding to the plurality of antennas during the beamforming operation with the gain values; and
determining a first plurality of gain calibration values corresponding to the plurality of antennas during the beamforming operation using the plurality of phase calibration values.

10. The method of claim 9, further comprising:
receiving, by the user equipment, a first resource assignment for determining the plurality of phase calibration values, wherein the determining the plurality of phase calibration values is performed using the first resource assignment; and
receiving, by the user equipment, a second resource assignment for determining the first plurality of gain calibration values, wherein the determining the first plurality of gain calibration values is performed using the second resource assignment.

11. The method of claim 10, further comprising:
receiving, by the user equipment, a third resource assignment for determining a second plurality of gain calibration values; and
determining a second plurality of gain calibration values corresponding to the plurality of antennas while beamforming using the plurality of phase calibration values using the third resource assignment.

12. The method of claim 11, wherein:
the first plurality of gain calibration values correspond to a first operating point comprising a first frequency and a first temperature value,
the second plurality of gain calibration values correspond to a second operating point comprising a second frequency and a second temperature value, and
at least one of the second frequency is different from the first frequency or the second temperature value is different from the first temperature value.

13. The method of claim 10, wherein:
determining the plurality of phase calibration values comprises receiving, by the user equipment, first feedback from a base station, wherein the plurality of phase calibration values is based on the first feedback; and
determining the first plurality of gain calibration values comprises receiving, by the user equipment, second feedback from the base station, wherein the first plurality of gain calibration values is based on the second feedback.

14. The method of claim 10, wherein:
the first resource assignment comprises a first number of symbols during which the user equipment is configured for determining the plurality of phase calibration values based on phase measurements, and
the first resource assignment comprises a second number of symbols greater than the first number of symbols during which the user equipment is configured for determining the plurality of phase calibrations values based on RSRP measurements.

15. The method of claim 10, wherein the first resource assignment comprises a first reference signal (RS) resource assignment, and the second resource assignment comprises a second reference signal (RS) resource assignment.

16. The method of claim 9, wherein:
determining the plurality of phase calibration values comprises transmitting a first reference signal (RS) in a millimeter wave band.
determining the first plurality of gain calibration values comprises transmitting a second reference signal (RS) in the millimeter wave band.

17. A base station (BS) comprising:
a memory storing processor-readable code; and
at least one processor coupled to the memory, the at least one processor configured to execute the processor-readable code to cause the at least one processor to perform operations including:
assigning resources to a user equipment (UE) for beamforming calibration, wherein the resources comprise a first resource assignment for determining a first plurality of gain calibration values;
transmitting a first signal to the UE during a first portion of the first resource assignment;
receiving a second signal from the UE during a second portion of the first resource assignment; and
transmitting feedback to the UE based on the second signal received during the second portion of the first resource assignment.

18. The base station of claim 17, wherein assigning the resources to the UE comprises assigning a second resource assignment for determining a plurality of phase calibration values.

19. The base station of claim 18, wherein assigning the resources to the UE comprises assigning a third resource assignment to the UE for determining a second plurality of gain calibration values.

20. The base station of claim 19, wherein:
the first plurality of gain calibration values correspond to a first operating point comprising a first frequency and a first temperature value,
the second plurality of gain calibration values correspond to a second operating point comprising a second frequency and a second temperature value, and
at least one of the second frequency is different from the first frequency or the second temperature value is different from the first temperature value.

21. The base station of claim 19, wherein:
the second resource assignment comprises a first number of symbols during which the user equipment is configured for determining the plurality of phase calibration values based on phase measurements, and
the second resource assignment comprises a second number of symbols greater than the first number of symbols during which the user equipment is configured for determining the plurality of phase calibrations values based on RSRP measurements.

22. The base station of claim 19, wherein the first resource assignment comprises a first reference signal (RS) resource assignment, and the second resource assignment comprises a second reference signal (RS) resource assignment.

23. The base station of claim 22, wherein transmitting the first signal to the UE during the first portion of the first resource assignment comprise transmitting a first reference signal (RS) in a millimeter wave band.

24. A method of wireless communication performed by a base station (BS), the method comprising:
assigning resources to a user equipment (UE) for beamforming calibration, wherein the resources comprise a first resource assignment for determining a first plurality of gain calibration values;
transmitting a first signal to the UE during a first portion of the first resource assignment;
receiving a second signal from the UE during a second portion of the first resource assignment; and
transmitting feedback to the UE based on the second signal received during the second portion of the first resource assignment.

25. The method of claim 24, wherein assigning the resources to the UE comprises assigning a second resource assignment for determining a plurality of phase calibration values.

26. The method of claim 25, wherein assigning the resources to the UE comprises assigning a third resource assignment to the UE for determining a second plurality of gain calibration values.

27. The method of claim 26, wherein:
the first plurality of gain calibration values correspond to a first operating point comprising a first frequency and a first temperature value,
the second plurality of gain calibration values correspond to a second operating point comprising a second frequency and a second temperature value, and
at least one of the second frequency is different from the first frequency or the second temperature value is different from the first temperature value.

28. The method of claim 26, wherein:
the second resource assignment comprises a first number of symbols during which the user equipment is configured for determining the plurality of phase calibration values based on phase measurements, and
the second resource assignment comprises a second number of symbols greater than the first number of symbols during which the user equipment is configured for determining the plurality of phase calibrations values based on RSRP measurements.

29. The method of claim 26, wherein the first resource assignment comprises a first reference signal (RS) resource assignment, and the second resource assignment comprises a second reference signal (RS) resource assignment.

30. The method of claim 29, wherein transmitting the first signal to the UE during the first portion of the first resource assignment comprise transmitting a first reference signal (RS) in a millimeter wave band.
